(19) United States
(12) Patent Application Publication
(10) Pub. No.: US 2021/0033855 A1
(43) Pub. Date: Feb. 4, 2021

(54) METHOD OF DESIGNING PROJECTION LENSES WITH PUPIL ABERRATION

(71) Applicant: ALTMAN LIGHTING, INC., Yonkers, NY (US)

(72) Inventor: PATRICK RENE DESTAIN, Allen, TX (US)

(73) Assignee: ALTMAN LIGHTING, INC., Yonkers, NY (US)

(21) Appl. No.: 16/526,089

(22) Filed: Jul. 30, 2019

(51) Int. Cl. G02B 27/00; G02B 15/14; G02B 9/12

(52) U.S. Cl. CPC G02B 27/0068; G02B 9/12; G02B 15/143

(57) ABSTRACT

A method to design projection lenses or zoom lenses with distorted or uncorrected pupil aberration (mostly Spherical Aberration or spherochromatism). By introducing some pupil aberration, the designer has a new variable to correct for field and aperture aberrations. The result is a design that requires fewer lens count for the same performance parameters than more complex projection lenses, and is more compact. Lenses designed by the method are illustrated.

### BACKGROUND OF THE INVENTION

### 1. Field of the Invention

The invention generally relates to lens design and, more specifically to a method of designing projection lenses with pupil aberration and lenses formed by the method.

### 2. Description of the Prior Art

Telecentricity requirement for projection lenses is known for LCD and digital light processing (DLP™) projectors where dichroic coatings require minimum angle of incidence variation (AOI) over the field of view (FOV) for color uniformity (and contrast) purposes. Telecentricity is defined as the beam pupil position at infinity, while the general literature considers entrance pupil position (EPP) on the object side of the lens, such as for a camera or on the panel side for projectors. In general, telecentric type design for projector is based on a retro-focus layout with a positive group and negative group of lenses on both sides of the aperture stop. That arrangement provides long back focal to accommodate filters or combination prisms between the object (LCD, DLP, or slide) and the first group of lenses.

As shown in FIG. 1, the aperture stop (AS) lies in between both groups (in this instance, the front group is just a single negative lens due to moderate FOV). The negative group becomes more complex with larger FOV and/or faster beam (i.e. smaller “fₙᵤₘ” value) but the rear group is always a set of 3, 4 or even more lenses depending on the Field and the Aperture. See FIG. 2. Furthermore, the diameter of the rear group lenses are usually 1.5 to 2× the FOV, depending on the fₙᵤₘ and minimum distance to clear slide or object to be projected through the lens onto a screen.

The other intrinsic property of this type of lens design is the high level of pupil imaging quality in the aperture stop plane (i.e. all Chief Rays (CR) intersect in the aperture stop plane on the Z-axis).

Total Track length is longer than the focal length (by definition) and sometimes not practical (in size, weight and cost) when the object (slide, digital micromirror device (DMD™) or LCD panel . . . ) is bigger than 1″ or so. Most lens designs (including projection lens) prefer, when possible non telecentric lenses, to minimize the cost and complexity of pupil imaging restriction.

In other applications, such as theatre lighting or more generally the entertainment business, light fixtures have commonly been designed around much bigger objects called GOBO. Such (transmissive) object are big (diameter ˜64.5 mm GOBO B-type) and are usually cut out of a metal plate (FIG. 3a) or etched on glass substrate (sometimes coloured glass) where more complex effects can be created (FIG. 3b). The GOBO is illuminated from its back side and then projected through some optics downstream on a stage or wall to create a desired light effect.

In order to better appreciate the present invention, but without restricting its field of application, we will consider some practical cases with standard dimensions such as a GOBO B (64.5 mm diameter) and beam aperture of about f/2.

Until today, lighting fixtures are made available with poor optical quality projection lenses called “tubes”, usually available in different fixed focal lengths (for different beam angles) or zooms. See FIGS. 4a and 4b. Typical beam angles commercially available are from 5, 10 degrees up to 90 degrees while zooms can be found off the shelf with beam angle ranges from 15-35 degrees and 30 to 50 degrees. Tube designs are usually based on two positive focal molded lens layout. Focus is adjusted by moving the entire lens assembly with respect to the GOBO plane. Such designs cannot fix Seidel aberrations such as field curvature or chromatic aberration (axial or longitudinal) even if aspheric surfaces are used because of the lack of lenses with negative power and/or the lenses are made out of flint glass.

From an optical standpoint, a tube optical design (fixed or zoom) is quite simple (see FIG. 5a) and is usually composed of two lenses (for fixed lenses as FIG. 5b both lenses LI and L2 are in proximity of each other and moved together for focus adjustment). In the case of zooms, (FIG. 5a), L2 is used to change the magnification while LI still compensates for refocusing vs zoom position AND Throw Distance.

As also shown in FIG. 5a, the back focal is quite short and sometimes interferes with the blades of the shutter that have to lie as close as possible to the focal plane location. The L1 surfaces can be aspheric on one side (or both sides) to minimize pupil aberration or distortion amongst other aberrations (Seidel doesn't take into account aspheric terms.) L2 is spherically shaped for low to moderate tube focal length.

The lens can be made fixed focal type (FIG. 5b): Both L1 and L2 are moved together for the purpose of focusing) or can be zoom-able (both L1 and L2 can be adjusted separately. FIG. 5a is an example of this type of design limitation: The aperture stop is now in front of lens L2 and, therefore, exhibits aberration such as later color or distortion among others which are hard to correct in this configuration at least without aspheric surfaces and flint glass.

Prior art regarding the present invention is always characterized by a good (corrected) image of the entrance pupil in the AS plane. Imaging quality has the same meaning as for the image of an object. Both front group (FG) and rear group (RG) are usually well corrected separately with a minimum compensation of aberration between the two groups. The main reason is for looser alignment tolerances between both groups. In prior art, front groups and rear groups are, as indicated, well corrected and, therefore, can be used separately.

### SUMMARY OF THE INVENTION

The present invention solves the optical quality limitation of existing tubes while keeping the optical design much simpler than a retrofocus lens layout. It also enables compact tubes design, with smaller (diameter) lenses.

The present invention starts with the idea that inherent or naturally occurring aberrations of the image of the pupil between lens groups shouldn't be corrected and, on the contrary, should be used to better correct aberration such as oblique, spherical or coma type by changing CR lateral position in the aperture stop plane. Some prior art designs (Tessar, Hektor lens) use a similar approach with a strongly curved cemented interface (doublet) and small index break outside. (FIG. 6) Correction is made outside the AS plane while the oblique beam marginal rays (upper and lower) hit the embedded surface with very different angles of incidence (AOI) to finely correct aberration without changing the first order properties of the lens.

The main design consequence of well corrected front group (FG) and rear group (RG) is that complexity is increased (more lenses are required because aberration compensation is restricted to each group separately).

The invention typically has a rear group RG with fewer lenses than in prior art lenses and intentionally does not correct for pupil image aberration in the AS plane. The main advantage of the invention is that now there is an additional degree of freedom to optimize the system by allowing the CR intersection location to shift depending on the field of view. It is usually Pupil Spherical aberration but can also be Chromatic aberration (CR intersection varies with the wavelength).

The consequence of the invention is that the front group FG can be slightly more complex (in terms of lenses) but with eventually higher optical image aberration correction and image quality (which would not normally be expected by lens designers).

Another signature of the invention is that the front group usually comprises more lenses than the rear group (which is usually the opposite with prior art where the rear group is more complex.)

### BRIEF DESCRIPTION OF THE FIGURES

The above and other aspects, features and advantages of the present invention will be more apparent from the following description when taken in conjunction with the accompanying drawings, in which:

FIG. 1 illustrates a prior art telecentric projection objective (retro-focus) 20 degrees FOV, f/2.8;

FIG. 2 illustrates a prior art telecentric LCD projection lens 50 deg FOV f/5;

FIG. 3a is an example of a GOBO made from a metal plate;

FIG. 3b is an example of a GOBO made on a glass substrate;

FIGS. 4a and 4b show a two lens tube for light fixtures (SPX 15-35 deg SELECON™);

FIG. 5a illustrates a prior art fixed or zoom-able tube lens layout (beam angle 15 degrees f/2);

FIG. 5b illustrates a prior art fixed or zoom-able tube layout (beam angle 35 degrees f/2) (same field and imaging lenses as in FIGS. 4a and 4b);

FIG. 6 is a prior art lens for oblique aberration correction with a strongly curved cemented interface;

FIG. 7 is a generalized diagrammatic representation of a projection lens in accordance with the present invention (paraxial AS (rays close to the optical axis) must be between RG and FG or embedded in FG and possibly even at the front of FG such as in 19 deg optical design);

FIG. 7a is a diagrammatic representation of a first example of a projection lens conforming to FIG. 7 having a field of view of 19° and the corresponding lens parameters;

FIG. 7b is a second example of a projection lens conforming to FIG. 7 having a field of view of 26° and the corresponding lens parameters;

FIG. 7c is a third example of a projection lens conforming to FIG. 7 having a field of view of 36° and the corresponding lens parameters;

FIG. 7d is a fourth example of a projection lens conforming to FIG. 7 having a field of view of 50° and the corresponding lens parameters;

FIG. 7e is a fifth example of a projection lens conforming to FIG. 7 having a field of view of 70° and the corresponding lens parameters;

FIG. 7f is a sixth example of a projection lens conforming to FIG. 7 having a field of view of 90° and the corresponding lens parameters;

FIGS. 7g and 7h illustrate eight field lens designs with Pupil Aberrations for improved projection optical quality measured in the Aperture Stop plane with gobos on the left and aperture stops on the right;

FIG. 7i illustrates four Projection lens designs for different beam angles with field lenses exhibiting pupil aberration;

FIGS. 7j and 7k illustrate a Projection lens design for a varifocal lens (30 degrees to 50 degrees FOV) and its associated field lens with pupil spherical aberration;

FIGS. 7l and 7m illustrate a Projection lens design for a varifocal lens (18 degrees to 35 degrees FOV) and its field lens with pupil spherical aberration;

FIG. 7n is a side-by-side comparison of a prior art 6 element wide angle telecentric projection lens assembly (U.S. Pat. No. 4,189,211) and a comparable lens in accordance with the invention, showing for each a lens layout and additional design and performance details;

FIG. 8a-1 shows a typical lens barrel design based on two sub-barrels in accordance to the invention (19 degrees);

FIG. 8a-2 illustrates the lens of FIG. 8a-1 in cross-section;

FIG. 8a-3 illustrates the lens barrel design of the lens shown in FIGS. 8a-1 and 8a-2;

FIGS. 8a-4 and 8a-5 illustrate a barrel design in accordance to the invention (19 degrees), shown in perspective, as prototyped and an exploded view, respectively;

FIGS. 8b-1 and 8b-2 are image patterns emanating from a barrel design in accordance with the invention depicting optical quality of the invention for a 19 degrees fixed lens with a beam diameter of approximately 1.9 m; and

FIGS. 9-15 illustrate exemplary embodiments of optical lens designs in accordance with the invention having fixed objectives of 10°, 19°, 50°, 70°, 90° and 18°-35° and 30°-50° zoom lenses, respectively, showing for each lens, layouts of the lens elements and additional design and performance details.

### DETAILED DESCRIPTION

The present invention solves the optical quality limitation of existing tubes while keeping the optical design much simpler than a retrofocus lens layout.

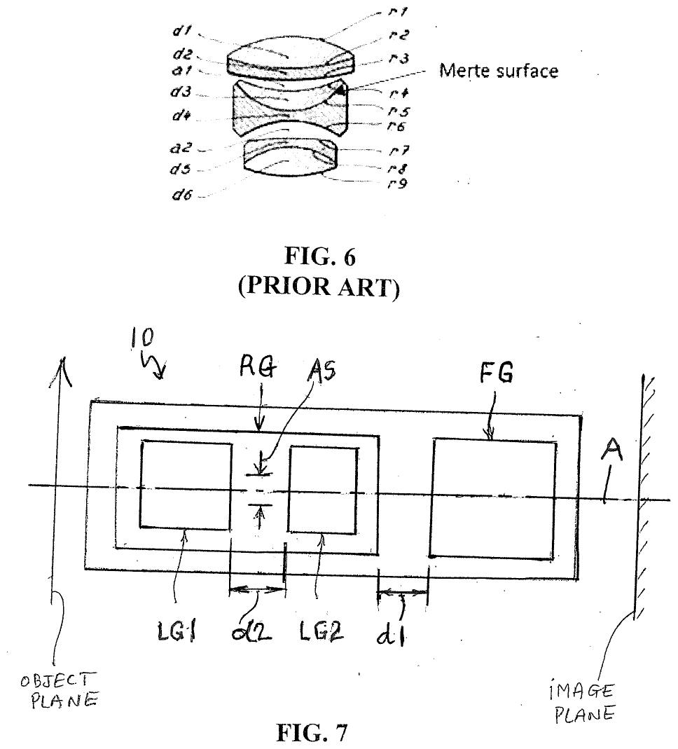

The invention is based on the central principle that pupil aberration should not be corrected and, on the contrary, should be used to better correct aberration such as oblique spherical or coma type by changing the chief rays (CR) lateral positions in the aperture stop (AS) plane. Some prior art designs (Tessar, Hektor lens) use a similar approach with a strongly curved cemented interface (doublet) and small index break outside (FIG. 6). Correction is made outside the AS plane while the oblique beam marginal ray (upper and lower) impinge on the embedded surface with very different angles of incidence (AOI).

Pupil image correction can be explained as follows: The Chief Rays (CR) of all points in the object plane intersect with the optical axis in the AS.

Instead of correcting for pupil aberration, the present invention uses the pupil aberration generated by the field lens to vary the beam position in the aperture stop plane. The beam position becomes a variable and gives the designer another degree of freedom to correct field and aperture aberrations.

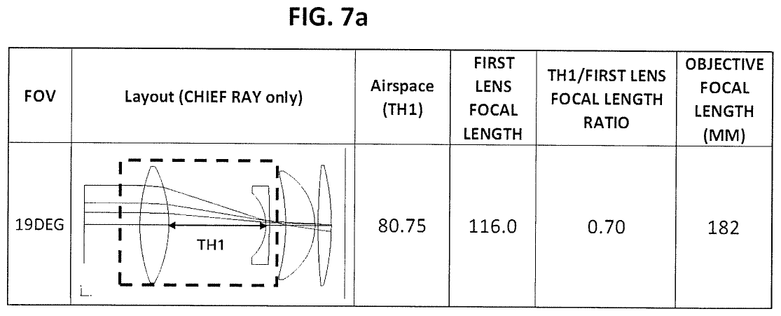

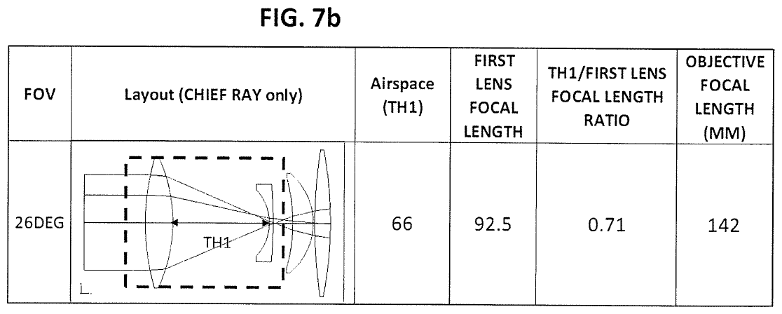

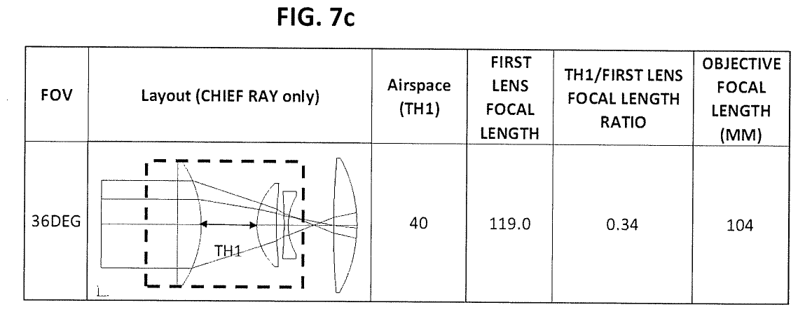

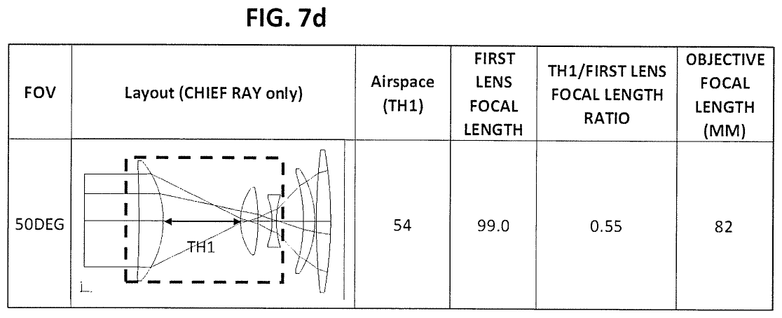

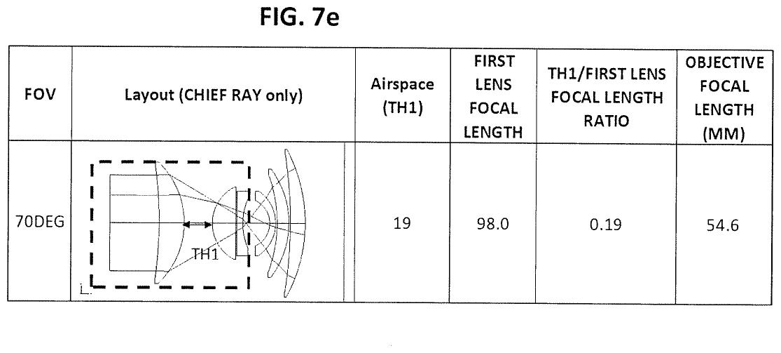

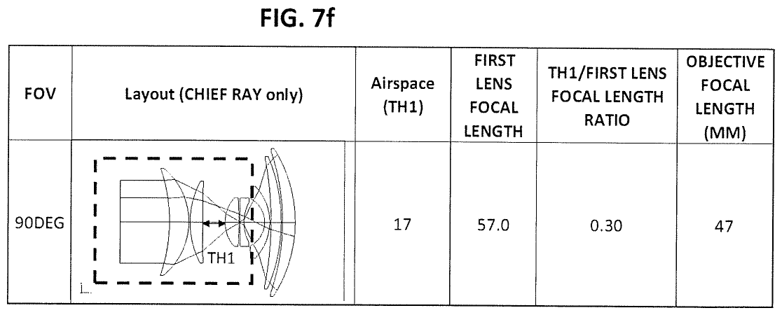

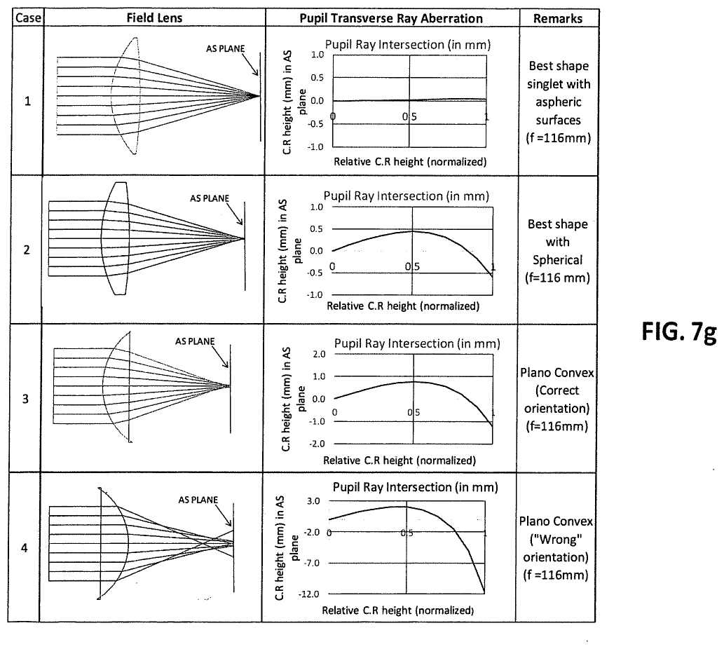

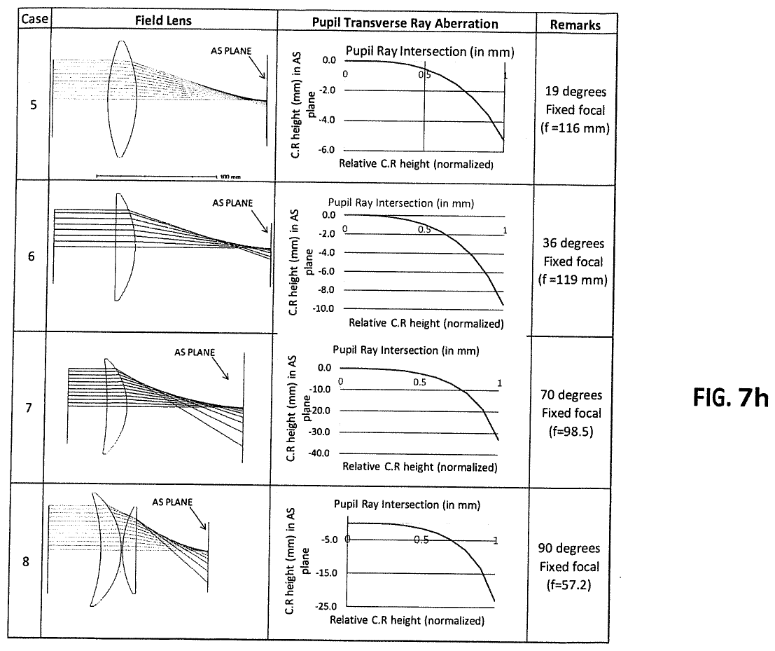

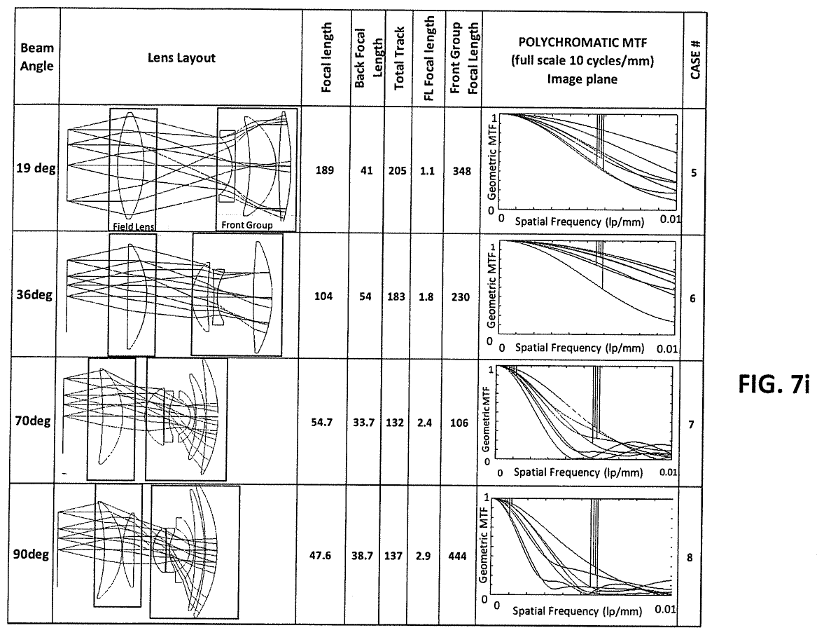

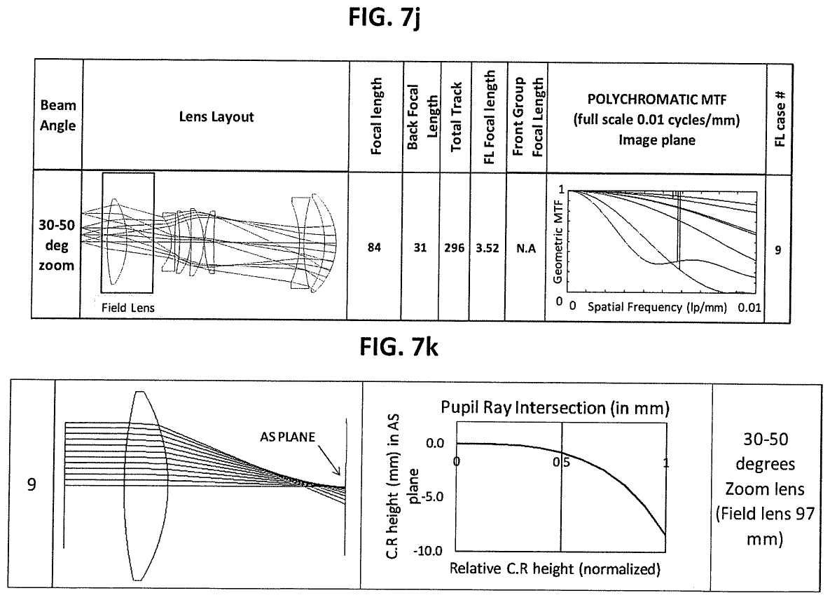

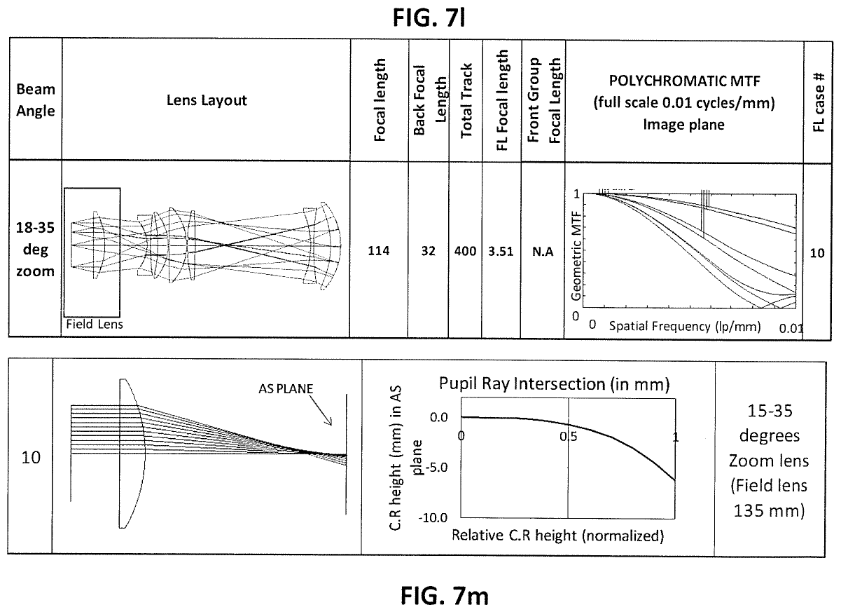

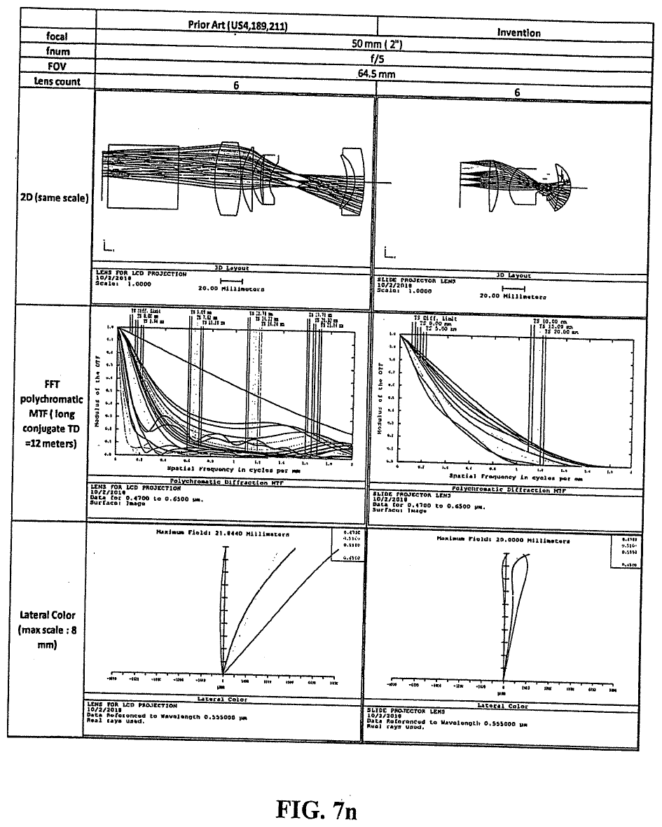

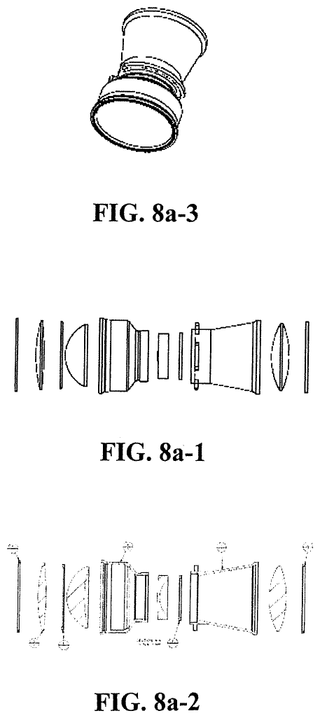

Referring to FIG. 7, an illustrative view of the invention is shown of a projection lens generally designated by the reference numeral 10. The projection lens 10 has an optical axis A and a field of view (FOV). The lens 10 has a rear lens group (RG) along the axis; a front lens group (FG) along the axis spaced from the RG a distance “d1”. The RG is formed of a first lens group (LG1) having a rear lens focal length “f” and a second lens group (LG2) spaced a distance “d2” from the LG1 along the axis, LG1 is more remote from and LG2 is more proximate to the FG. The RG is selected to exhibit pupil image aberration in the AS plane to laterally displace chief rays (CR) with respect to the optical axis. The RG images the entrance pupil in the AS plane. Greater pupil aberrations of the RG group is required when the Beam Angle gets bigger. More efficient aberration correction is enabled of the imaging or projection lens by allowing CR intersection locations to shift as a function of the FOV. The projection lens 10 enables the pupil image aberration of the RG to be used to correct at least one of oblique, spherical and coma aberrations by changing the CR lateral positions in the AS plane. The projection lens 10 also enables the CR lateral positions or CR intersection locations to be used to correct chromatic aberrations.

Typically, the projection lens 10 will have a fewer number of lenses in the RG than in the FG.

The distance “d2” between the lens groups LG1 and LG2 is a function of the FOV.

The projection lens 10 will typically have a lens group LG1 that includes a positive lens most remote from LG2. Also, the projection lens group LG2 typically includes a negative lens most remote from LG1.

The distance d2 is approximately equals to 0.7 f for FOV within the range of 10-30°. The distance d2 is approximately within the range of 0.4-06 off for FOV within the range of 30-50°. Also, the distance d2 is approximately within the range of 0.2-0.4 of f for FOV within the range of 50-90°.

The projection lens 10 may have both RG and FG with positive focal lengths. Preferably, the RG has a focal length that is 1/3 times the focal length of the FG. However, the focal length of the RG may be selected to be > 2/3 of the focal length of the FLG.

The projection lens may be a fixed lens or a zoom lens or varifocal lens. The projection lens 10 can provide almost any desired FOV. See FIGS. 7a-7f. The projection lens 10 may be arranged to provide pupil image aberration in the form of spherical aberration. The projection lens may have a paraxial image Z-location of the entrance pupil in front of FG and in between RG and LG for higher FOV.

The projection lens may be used to project an image of an object and wherein said RG has a size selected to be approximately equal to the size of the object as well as an RG selected to have a size equal to 1.2-2 times the size of the object.

A method of correcting aberrations of a projection lens 10 having an optical axis A and a field of view (FOV), includes the steps of providing a rear lens group (RG) along the axis A front lens group (FG) is provided along the axis spaced from the RG, said RG being formed of a first lens group (LG1) having a rear lens focal length “f” and a second lens group (LG2) spaced a distance “d2” from the LG1 along the axis. LG1 is typically arranged to be more remote from and LG2 is more proximate to the FG. The RG exhibits pupil image aberration i.e. the Z-location of a CR close to the optical axis crossing the optical axis is different from the Z-location of a CR for a bigger FOV. By displacing the chief rays (CR) with respect to the optical axis the RG images the entrance pupil in the AS plane. Greater pupil aberrations of the RG group enables more efficient aberration correction of the imaging or projection lens for higher beam angle by allowing CR intersection locations to shift as a function of the FOV.

Referring to FIG. 7g some field lens designs are shown. Pupil Aberration is defined and measured as the lateral displacement (in mm) of the CR (Chief Ray) with respect to the optical axis (for on axis lenses) or with respect to the minimum field (for design with field offset such as projectors) in the AS plane. AS plane location becomes a function of the CR height (i.e. FOV).

Prior art and common rules as used in optical design practice would pick case 1, 2, or 3 as good design assumptions to properly design a retrofocus lens with moderate to high output beam angle. The present invention shows that they are not. While the objective beam angle is small or moderate, the aberration introduced by a single Field Lens is small but definitively not negligible. For Higher Beam angle (shorter focal length) the Field Lens designs now exhibit even stronger pupil aberrations (shown in FIG. 7h cases 5-8) are more efficient to correct projection lens for better optical quality without associated lens count increase and lens complexity as for a Retrofocus lens. Also FIG. 7n for a comparative analysis between prior art and present invention.

Numerical optimizations based on conventional Merit Function provide the following designs shown in FIG. 7h with field lens as described in case 5, 6 ,7 and 8 instead of “well corrected” field lenses (cases 1, 2, 3, 4) shown in FIG. 7g.

FIG. 7k is a similar improved lens (case 9) for a 30-50 zoom lens and FIG. 7m for a 15-35 zoom lens.

Lens layouts and performances parameters are shown in FIG. 7i for a f/2 beam with no vignetting. The lens layouts are for 19°, 36°, 70° and 90° beam angles showing for each the optical transfer functions (MTF) reflecting image quality.

Another signature of the invention is the relatively large airspace between the field lens group RG and the front lens group FG. As a rule of thumb and without restriction to the actual invention, the airspace d1 (FIG. 7) between the rear lens group (RG) and the front lens group (FG) is about ½ its focal length for moderate beam FOV down to ⅓ or ¼ field lens focal length for wide angle (˜70 to 90 degrees and up).

Also the front lens group FG focal length is positive (as for the rear lens group RF, (+,+)), which is another difference from retrofocus lens type (+ −), albeit the back focal length is about ⅓ times the focal length or larger. For very wide angles (70, 90 degrees), the back focal length can be as high as or higher than 2/3 of the focal length (see FIG. 7i). It provides more room than conventional field lens based designs without the complexity of a retrofocus lens. FIG. 7j illustrates a lens layout for a 30-50° zoom lens while FIG. 71 shows an 18-35° zoom lens.

The same invention can be applied to zoom lenses or varifocal lenses based on two groups or more with the associated field lens as shown in FIGS. 7j and 7k (30°-50° FOV) and in FIGS. 71 and 7m (for 18°-35° FOV).

FIG. 7n is a side-by-side comparison of a prior art 6 element wide angle telecentric projection lens assembly (U.S. Pat. No. 4,189,211) and comparable lens in accordance with the invention, showing for each a lens layout and additional design and performance details. The Fast Fourier Transform (FFT) polychromic modulation transfer functions (MTF) are compared for the two projection lenses as are the lateral color spreads or deviations.

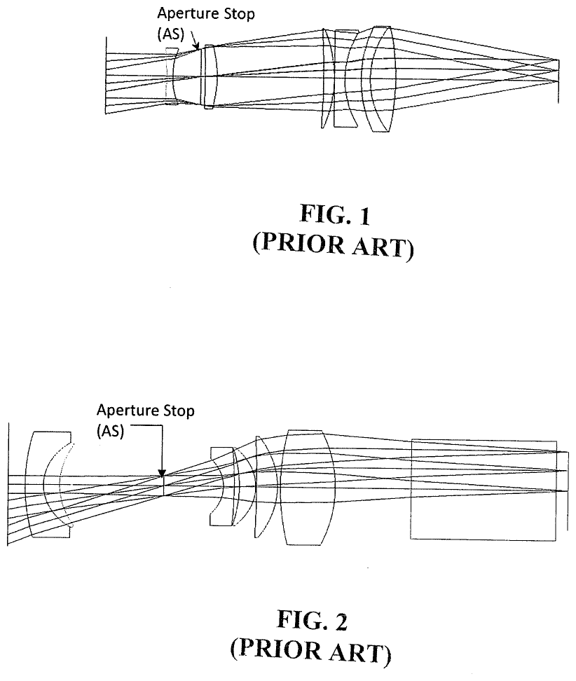

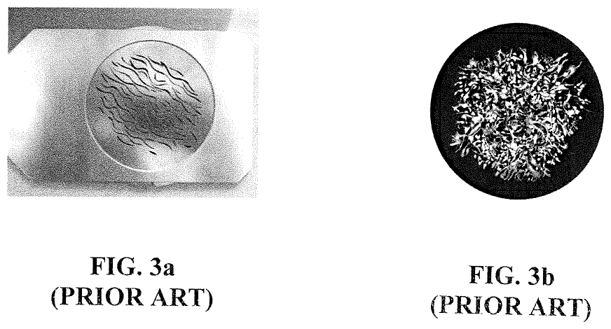

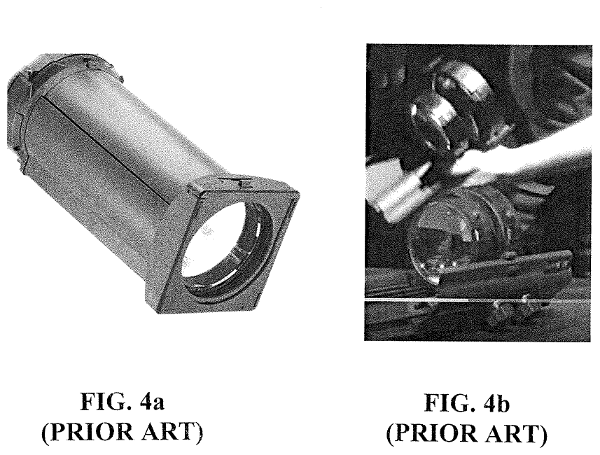

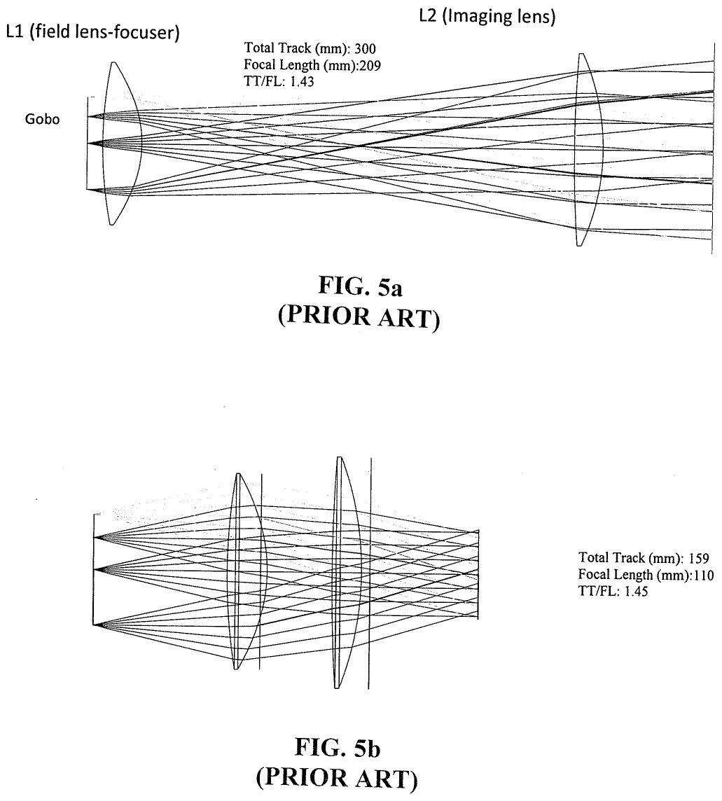

A preferred opto-mechanical lens based on a two conic shaped barrel designs has been proven to be lighter and cheaper than more complex straight tubes with additional airspacers as shown in FIGS. 8a-1 to 8a-5. FIGS. 8a-1 and 8a-2 depict a typical mechanical barrel design based on two sub-barrels indicating the lens arrangements while FIGS. 8a-3 to 8a-5 show renderings of a prototype incorporating the shown lens arrangement.

FIGS. 8b-1 and 8b-2 depict the optical quality of the invention for a 19 degrees fixed lens with beam diameter of approximately 1.9 m.

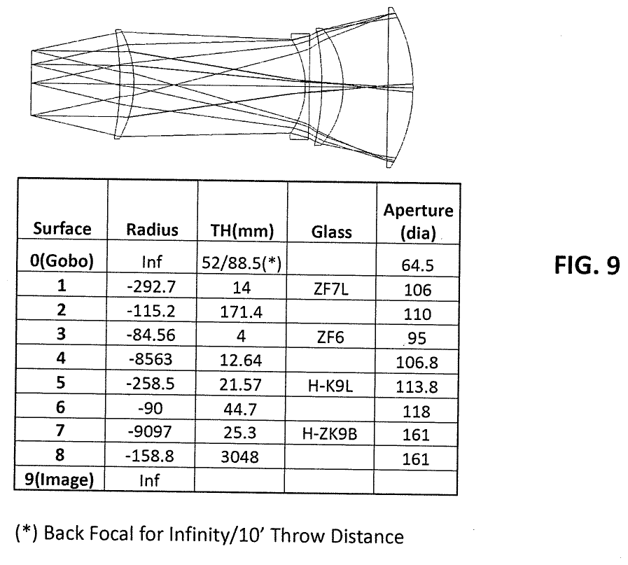

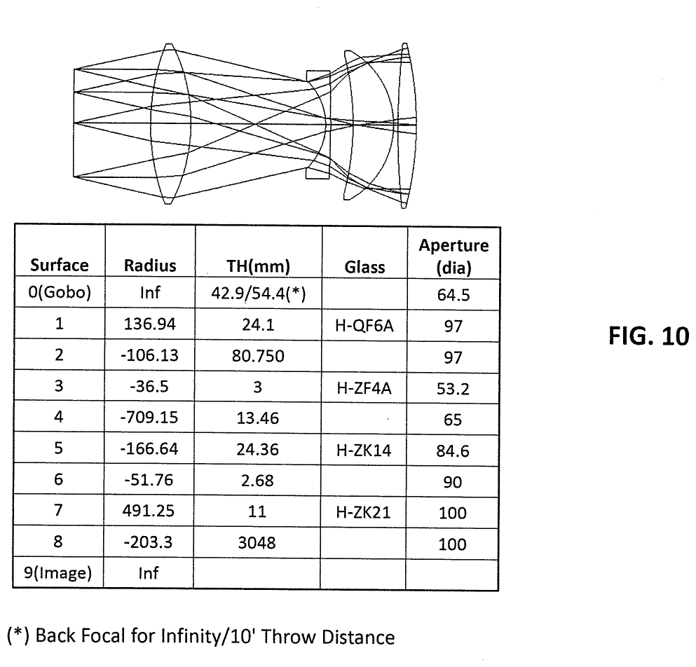

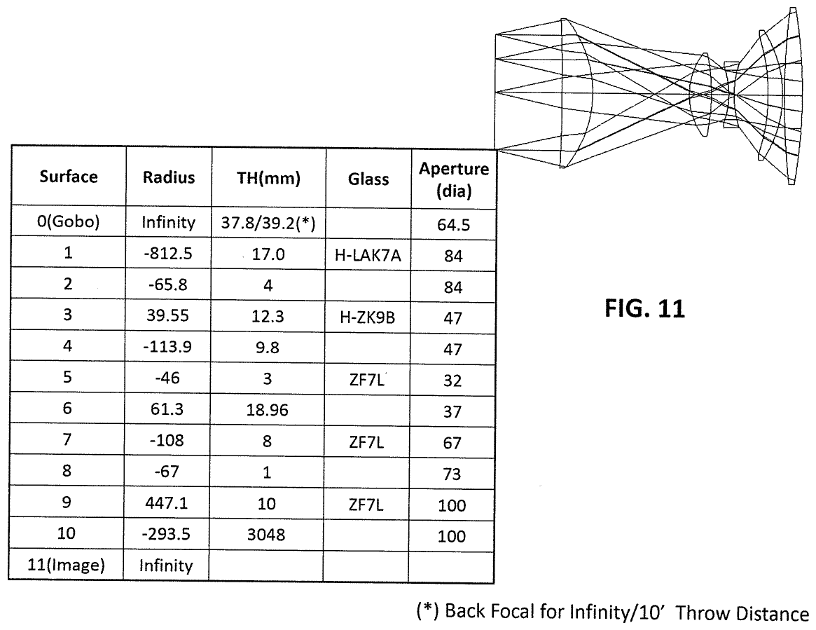

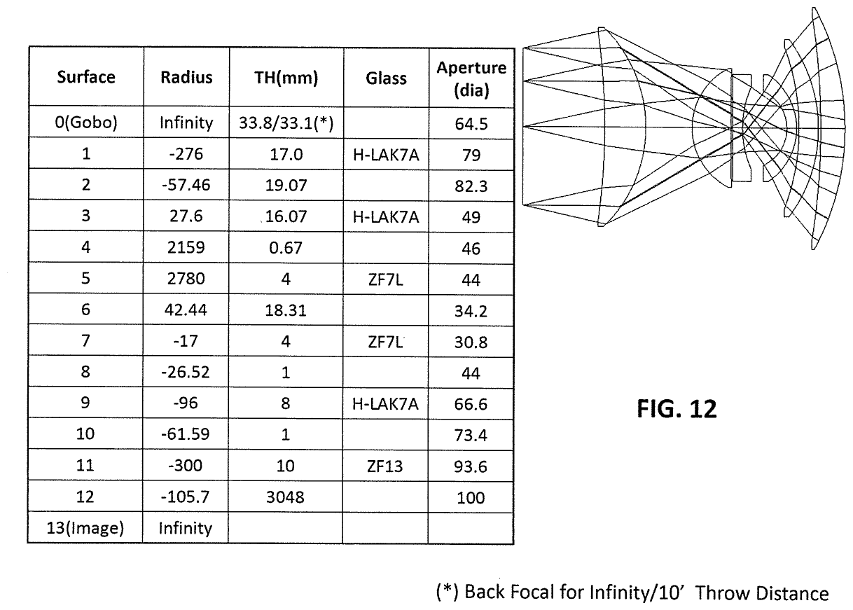

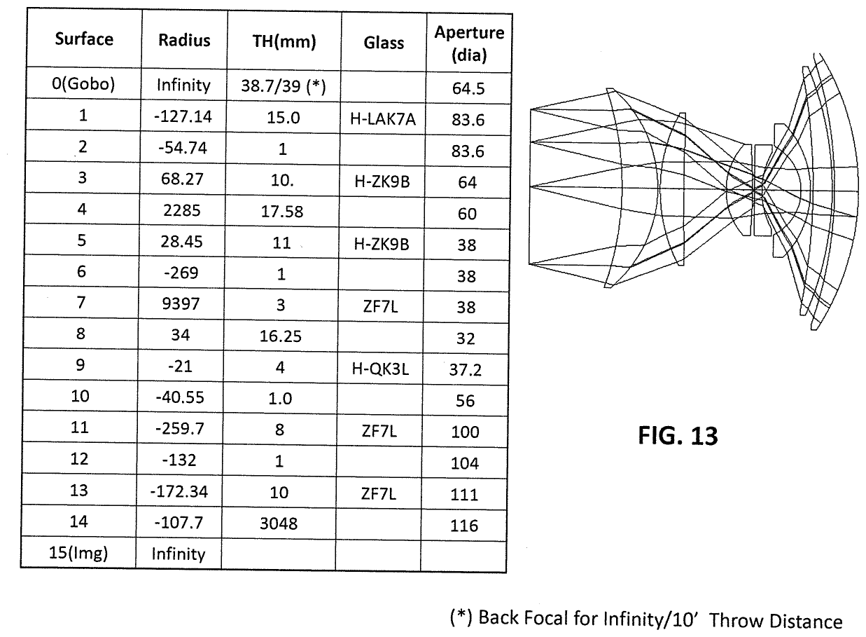

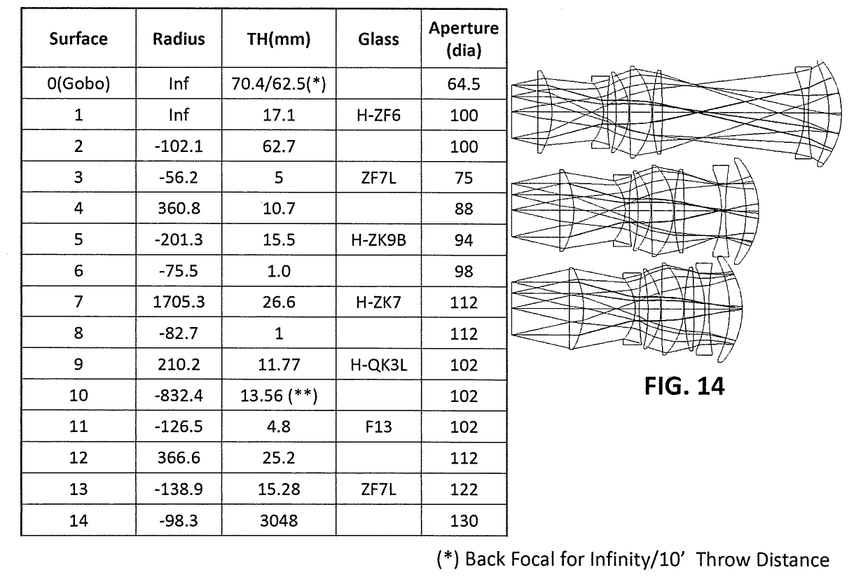

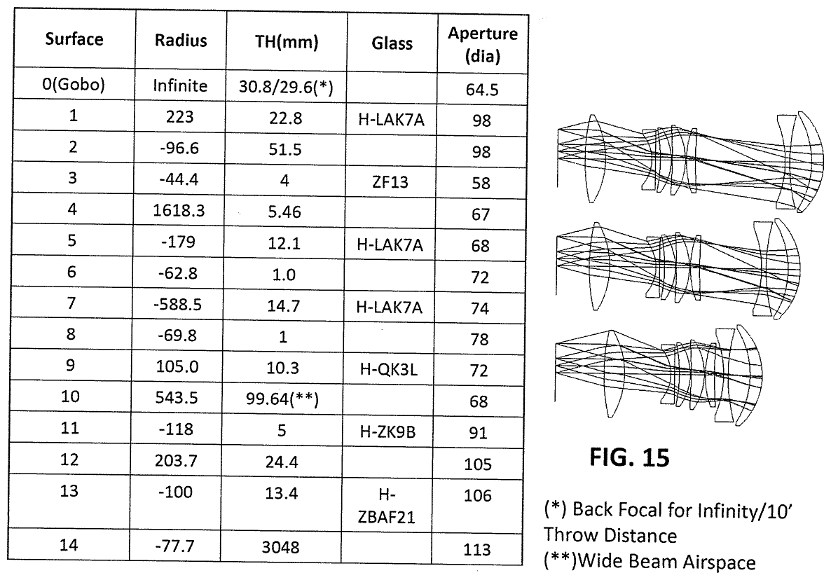

FIGS. 9-15 illustrate exemplary embodiments of optical lens designs in accordance with the invention having fixed objectives of 10°, 19°, 50°, 70°, 90° and 18°-35° and 30°-50° zoom lenses, respectively, showing for each lens, layouts of the elements or lenses and additional design and performance details.

The main element(s) of the invention include a field lens or a group of lenses that serve as a field lens designed with pupil aberration, usually spherical aberration.

Telecentricity is not required for the invention. It is just another situation compared to an entrance pupil not located at infinity. The main aspect of the invention is an optical system for imaging an object onto a screen. The system comprises a number of lenses with the image of the entrance pupil embedded inside. It is coincident with the aperture stop (AS) location. The system is usually (but not always) composed of a front group of lenses and a rear group of lenses. “Front” is usually understood as “between the AS and the image plane and “Back” from the AS to the object. There are two types of optical systems with distinct front and rear group: Retrofocus lenses (Front is usually negative power and Rear positive power) or Double Gauss where both groups are positive around AS. The Rear group images the entrance pupil in the AS plane.

The designs shown and described above characterize the present invention by the presence of a field lens or group of lenses next to the object and about the same size as the object (1.2 to 2). The airspace between the field lens and the next group being substantial, about 1/3 to 1/2 the length of the field lens.

Projection lenses in accordance with the invention are suitable for all theatre applications with imaging requirements. They can include moving lights and for use as a regular projector lens for movies and cinema.

The invention overcomes problems or disadvantages of prior art designs by providing a method to design telecentric and other lenses with fewer and smaller diameter lenses that provide excellent optical quality. The resulting designs are also more compact than a retrofocus lens.

Techniques for designing the lenses of the FG to address and correct for aberrations (either inherent or introduced) by the RG are well known to those skilled in the art of designing of optical lenses. See “History of the Photographic Lens” by Rudolf Kingslake (1989), pages 50-174, which are incorporated as if fully set forth herein.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A projection lens having an optical axis and a field of view (FOV), comprising a rear lens group (RG) along said axis; a front lens group (FG) along said axis spaced from said RLG, said RLG being formed of a first lens group (LG1) having a rear lens focal length “f” and a second lens group (LG2) spaced a distance “d” from said LG1 along said axis, LG1 being more remote from and LG2 being more proximate to said FG; said RG exhibiting pupil image aberration in the AS plane to laterally displace chief rays (CR) with respect to said optical axis, said RG imaging the entrance pupil in said AS plane, whereby greater pupil aberrations of said RG group enables more efficient aberration correction of said imaging or projection lens by allowing CR intersection locations to shift as a function of the FOV.

2. A projection lens as defined in claim 1, wherein said pupil image aberration of said RG is used to correct at least one of oblique, spherical and coma aberrations by changing CR lateral positions in said AS plane.

3. A projection lens as defined in claim 1, wherein said CR lateral positions allow CR intersection locations to correct chromatic aberrations.

4. A projection lens as defined in claim 1, wherein said FG comprises a fewer number of lenses than said RG.

5. A projection lens as defined in claim 1, wherein said distance “d” between said lens groups LG1 and LG2 is a function of the FOV.

6. A projection lens as defined in claim 1, wherein LG1 includes a positive lens most remote from LG2.

7. A projection lens as defined in claim 1, wherein LG2 includes a negative lens most remote from LG1

8. A projection lens as defined in claim 6, wherein d is approximately equals to 0.7 f for FOV within the range of 10-30°.

9. A projection lens as defined in claim 6, wherein d is approximately within the range of 0.4-06 of f for FOV within the range of 30-50°.

10. A projection lens as defined in claim 6, wherein d is approximately within the range of 0.2-0.4 of f for FOV within the range of 50-90°.

11. A projection lens as defined in claim 1, wherein both RG and FG have positive focal lengths.

12. A projection lens as defined in claim 1, wherein said RG has a focal length that is 1/3 times the focal length of said FG.

13. A projection lens as defined in claim 1, wherein the focal length of said RG is> 2/3 of the focal length of said FG.

14. A projection lens as defined in claim 1, wherein said projection lens is a zoom lens.

15. A projection lens as defined in claim 1, wherein said projection lens is a varifocal lens.

16. A projection lens as defined in claim 1, wherein the projection lens has a FOV within the range of 30°-50°.

17. A projection lens as defined in claim 1, wherein the projection lens has a FOV within the range of 18°-35°.

18. A projection lens as defined in claim 1, wherein said pupil image aberration is spherical aberration.

19. A projection lens as defined in claim 1, wherein the projection lens is used to project an image of an object and wherein said RG has a size selected to be approximately equal to the size of the object.

20. A projection lens as defined in claim 1, wherein said RG has a size equal to 1.2-2 times the size of the object.

21. A projection lens as defined in claim 1, wherein said distance “d” between said LG1 and LG2 lens groups of said RLG along said axis being within the range of approximately 0.2-0.7 the focal length “f” of said rear lens.

22. A method of correcting aberrations of a projection lens having an optical axis and a field of view (FOV), comprising the steps of providing a rear lens group (RG) along said axis; providing a front lens group (FG) along said axis spaced from said RG, said RG being formed of a first lens group (LG1) having a rear lens focal length “f” and a second lens group (LG2) spaced a distance “d” from said LG1 along said axis, LG1 being more remote from and LG2 being more proximate to said FG; said RG exhibiting pupil image aberration in the AS plane; laterally displacing chief rays (CR) with respect to said optical axis, said RG imaging the entrance pupil in said AS plane; selecting said distance “d” between said LG1 and LG2 lens groups of said RG along said axis to be within the range of approximately 0.2-0.7 the focal length “f” of said rear lens, whereby greater pupil aberrations of said RG group enables more efficient aberration correction of said imaging or projection lens by allowing CR intersection locations to shift as a function of the FOV.

23. A method of correcting aberrations of a projection lens as defined in claim 22, wherein selecting said distance “d” between said LG1 and LG2 lens groups of said RLG along said axis to be within the range of approximately 0.2-0.7 the focal length “f” of said rear lens.
